(19) United States
(12) Patent Application Publication
(10) Pub. No.: US 2026/0246390 A1
(43) Pub. Date: Aug. 20, 2026

(54) CONVERTER AND CONTROL METHOD, SST SYSTEM AND CONTROL METHOD

(71) Applicant: Delta Electronics (Shanghai) CO., LTD., Shanghai (CN)

(72) Inventors: Hong LIU, Shanghai (CN); Wen ZHANG, Shanghai (CN); Yuxin HAN, Shanghai (CN); Weiqiang ZHANG, Shanghai (CN); Wenfei HU, Shanghai (CN); Xing ZHANG, Shanghai (CN); Junshan LOU, Shanghai (CN)

(73) Assignee: Delta Electronics (Shanghai) CO., LTD., Shanghai (CN)

(21) Appl. No.: 19/540,572

(22) Filed: Feb. 13, 2026

(30) Foreign Application Priority Data
Feb. 18, 2025 (CN) 2025101812565

(51) Int. Cl. H02M 3/335; H02M 1/00; H02M 1/08; H02M 7/483; H02M 7/493

(52) U.S. Cl. CPC H02M 3/33507; H02M 1/007; H02M 1/08; H02M 7/4835; H02M 7/493

(57) ABSTRACT

The present disclosure provides a converter and a control method, an SST system and a control method, and relates to the technical field of converters. The converter includes: a first conversion module including a first AC port and a second AC port, and converting a first AC to a second AC or converting the second AC to the first AC; a multi-port module transmitting the second AC; a second conversion module including a plurality of second conversion subunits, where power transmitted by the second AC port contains power of a second harmonic component of a frequency of the first AC.

### CROSS REFERENCE

This application is based upon and claims priority to Chinese Patent Application No. 2025101812565, filed on Feb. 18, 2025, the entire contents thereof are incorporated herein by reference.

### TECHNICAL FIELD

The present disclosure relates to the technical field of converters, and in particular, to a converter and a control method, an SST system and a control method.

### BACKGROUND

With the rise of renewable energy, the scale of photovoltaic, electric vehicles, and battery energy storage industries is getting larger and larger. Traditional power-consuming equipment is gradually required to assume part of the power generation function to cooperate with the peak-shaving and valley-filling of the power grid. Therefore, for AC/DC converters used in new energy occasions, it is an inevitable trend to achieve bidirectional flow of energy.

It should be noted that the information disclosed in the above background section is only used to enhance the understanding of the background of the present disclosure, and therefore may include information that does not constitute prior art known to ordinary technicians in the field.

### SUMMARY

According to the first aspect of the present disclosure, a converter is provided, including:
a first conversion module, including a first AC port and a second AC port, and configured to convert a first AC to a second AC, or to convert the second AC to the first AC;
a multi-port module, including a first port and a plurality of second ports, and configured to transmit the second AC; where the first port is electrically connected to the second AC port; and
a second conversion module, including a plurality of second conversion subunits, where each of the second conversion subunits includes one third AC port and one first DC port, and the plurality of third AC ports are electrically connected to the plurality of second ports in a one-to-one correspondence;
where power transmitted by the second AC port includes power of a second harmonic component of a frequency of the first AC.

According to the second aspect of the present disclosure, a control method for a converter is provided, which is applied to the converter provided in the first aspect, and the method includes:
acquiring a real-time voltage value and a real-time current value of the first AC of the first AC port of the first conversion module;
acquiring first DC port voltage values of a plurality of first DC ports of the second conversion module; and
calculating a phase shift angle corresponding to each of the third AC ports according to the real-time voltage value and the real-time current value of the first AC and the first DC port voltage values of the plurality of first DC ports, and performing a phase shift control on the plurality of second conversion subunits in the second conversion module based on the phase shift angle corresponding to each of the third AC ports, so that the power transmitted by the second AC port includes the power of a second harmonic component of a frequency of the first AC.

According to the third aspect of the present disclosure, a solid-state transformer (SST) system is provided, where each phase of the SST system includes a plurality of converters provided in the first aspect, and each of the converters includes a first end and a second end;
the first ends of the plurality of converters in each phase of the SST system are sequentially connected in series and then connected to a same phase AC power supply; and
the second ends of the plurality of converters in each phase of the SST system are electrically connected to form an output end of each phase of the SST system.

According to the fourth aspect of the present disclosure, a control method for an SST system is provided, which is applied to the SST system described in the third aspect, and the control method for the SST system includes:
acquiring a voltage value of each phase AC power supply connected to the SST system; and
determining a working number of converters corresponding to each phase AC power supply connected to the SST system according to the acquired voltage value of each phase AC power supply connected to the SST system.

According to the fifth aspect of the present disclosure, a converter control device is provided, including:
a first conversion module, a multi-port module, a second conversion module and a control module;
where the first conversion module includes a first AC port and a second AC port, and is configured to convert a first AC into a second AC, or convert the second AC into the first AC;
the multi-port module includes a first port and a plurality of second ports, and is configured to transmit the second AC; the first port is electrically connected to the second AC port;
the second conversion module includes a plurality of second conversion subunits, each of the second conversion subunits includes one third AC port and one first DC port, and the plurality of third AC ports are electrically connected to the plurality of second ports in a one-to-one correspondence; and
the control module is electrically connected to the first conversion module and the second conversion module, and is configured to perform a phase shift control on the plurality of second conversion subunits in the second conversion module, so that power transmitted by the second AC port includes power of a second harmonic component of a frequency of the first AC.

According to the sixth aspect of the present disclosure, a working method of a converter control device is provided, which is applied to the converter control device described in the fifth aspect, and the working method of the converter control device includes:
acquiring a real-time voltage value and a real-time current value of the first AC of the first AC port of the first conversion module using the control module;
acquiring first DC port voltage values of a plurality of first DC ports of the second conversion module using the control module;
calculating a phase shift angle corresponding to each of the third AC ports according to the real-time voltage value and the real-time current value of the first AC and the first DC port voltage values of the plurality of first DC ports and performing phase shift control on the plurality of second conversion subunits in the second conversion module based on the phase shift angle corresponding to each of the third AC ports using the control module, so that power transmitted by the second AC port comprises power of a second harmonic component of a frequency of the first AC.

According to the seventh aspect of the present disclosure, a converter is provided, includes:
a first conversion module, including a fourth DC port and a fourth AC port, and configured to convert a fourth DC power into a fourth AC power, or convert the fourth AC power into the fourth DC power;
a multi-port module, including a first port and a plurality of second ports, and configured to transmit the fourth AC power; where the first port is electrically connected to the fourth AC port;
a second conversion module, including a plurality of second conversion subunits, where each of the second conversion subunits includes one third AC port and one first DC port, and the plurality of third AC ports are electrically connected to the plurality of second ports in a one-to-one correspondence;
where the second conversion subunit is configured to convert a third AC power into a first port DC, or convert the first port DC into the third AC power.

According to the eighth aspect of the present disclosure, a control method for a converter is provided, which is applied to the converter described in the seventh aspect, and the control method for the converter includes:
acquiring a voltage value of the fourth DC port of the first conversion module;
acquiring voltage values of a plurality of first DC ports of the second conversion module; and
determining a number of bypassed second conversion subunit in the plurality of second conversion subunits in the second conversion module according to the voltage value of the fourth DC port and the voltage value of the first DC port.

It should be understood that the above general description and the detailed description below are only exemplary and explanatory, and cannot limit the present disclosure.

### BRIEF DESCRIPTION OF THE DRAWINGS

The accompanying drawings are incorporated into the specification and constitute a part of the specification, illustrating embodiments in accordance with the present disclosure and used together with the specification to explain the principles of the present disclosure. It is obvious that the drawings described below are only some embodiments of the present disclosure. For those skilled in the art, other drawings can be obtained based on these drawings without creative labor.

FIG. 1 shows a simplified structural diagram of a converter in an embodiment of the present disclosure;

FIG. 2 shows a simplified structural diagram of a first conversion module in an embodiment of the present disclosure;

FIG. 3 shows a second schematic diagram of a circuit structure of a first conversion subunit II in some embodiments of the present disclosure;

FIG. 4 shows a third schematic diagram of the circuit structure of the first conversion subunit II in some embodiments of the present disclosure;

FIG. 5 shows a fourth schematic diagram of the circuit structure of the first conversion subunit II in some embodiments of the present disclosure;

FIG. 6 shows a schematic diagram of a circuit structure of a first bridge circuit in a first conversion subunit III in some embodiments of the present disclosure;

FIG. 7 shows a schematic diagram of a circuit structure of a second bridge circuit in the first conversion subunit III in some embodiments of the present disclosure;

FIG. 8 shows a schematic diagram of a circuit structure of two unidirectional switches in reverse series in some embodiments of the present disclosure;

FIG. 9 shows a schematic diagram of a circuit structure of an integrated bidirectional switch in some embodiments of the present disclosure;

FIG. 10 shows a schematic diagram of a circuit structure of a multi-port module in some embodiments of the present disclosure;

FIG. 11 shows a first schematic diagram of a circuit structure of the second conversion subunit in some embodiments of the present disclosure;

FIG. 12 shows a second schematic diagram of a circuit structure of the second conversion subunit in some embodiments of the present disclosure;

FIG. 13 shows a third schematic diagram of a circuit structure of the second conversion subunit in some embodiments of the present disclosure;

FIG. 14 shows a schematic diagram of an implementation process of a control method in an embodiment of the present disclosure;

FIG. 15 shows a schematic diagram of an implementation process of step S1406 in some embodiments of the present disclosure;

FIG. 16 shows a schematic diagram of an implementation process of step S1406 in some embodiments of the present disclosure;

FIG. 17 shows a schematic diagram of an implementation process of a control method for a converter in some embodiments of the present disclosure;

FIG. 18 shows a schematic diagram of an implementation process of acquiring a current reference value of a first alternating current (AC) in some embodiments of the present disclosure;

FIG. 19 shows a schematic diagram of a circuit structure of a converter in some embodiments of the present disclosure;

FIG. 20 shows a schematic diagram of an implementation process of another control method for a converter in some embodiments of the present disclosure;

FIG. 21 shows a schematic diagram of a correlation relationship between the number of second conversion subunits put into operation and the absolute value of the voltage reference value of the first AC in some embodiments of the present disclosure;

FIG. 22 shows a schematic diagram of a circuit structure of a converter in a specific example of the present disclosure;

FIG. 23 shows a schematic diagram of a basic principle of phase shift control of the converter in a specific example of the present disclosure;

FIG. 24 shows a schematic diagram of the principle of realizing full range ZVS control of the second conversion subunit in the inversion mode of the converter in a specific example of the present disclosure;

FIG. 25 shows a control block diagram of the converter working in the inversion mode in a specific example of the present disclosure;

FIG. 26 shows a simulation waveform diagram of the converter working in the inversion mode in a specific example of the present disclosure;

FIG. 27 shows a schematic diagram of the principle of realizing ZVS in the lagging legs of two second conversion subunits in a specific example of the present disclosure;

FIG. 28 shows a schematic diagram of the operation mode of the converter generating reactive power in a specific example of the present disclosure;

FIG. 29 shows a schematic diagram of the control logic adopted by the converter generating reactive power in a specific example of the present disclosure;

FIG. 30 shows a simulation waveform diagram of the working condition of the converter generating reactive power in a specific example of the present disclosure;

FIG. 31 shows a schematic diagram of the simulation effect of the converter after bypass control in a specific example of the present disclosure;

FIG. 32 shows a schematic diagram of an implementation circuit adopting a bidirectional switch in a specific example of the present disclosure;

FIG. 33 shows a simple structural schematic diagram of a solid-state transformer (SST) system in the embodiment of the present disclosure;

FIG. 34 shows a schematic diagram of the control method for the SST system applied to the SST system shown in FIG. 33 in the embodiment of the present disclosure;

FIG. 35 shows a schematic diagram of an implementation process of step S3404 in some embodiments of the present disclosure;

FIG. 36 shows a simple structural schematic diagram of a converter control device in the embodiment of the present disclosure;

FIG. 37 shows a schematic diagram of the working method of a converter control device applied to the converter control device shown in FIG. 36 in the embodiment of the present disclosure;

FIG. 38 shows a simple structural schematic diagram of another converter in the embodiment of the present disclosure; and

FIG. 39 shows a schematic diagram of the control method applied to the converter shown in FIG. 38 in the embodiment of the present disclosure.

### DETAILED DESCRIPTION

The example embodiments will now be described more fully with reference to the accompanying drawings. However, the example embodiments can be implemented in a variety of forms and should not be construed as limited to the examples set forth herein; rather, these embodiments are provided so that the present disclosure will be more comprehensive and complete and the concepts of the example embodiments will be fully conveyed to those skilled in the art. The described features, structures, or characteristics may be combined in one or more embodiments in any suitable manner.

In addition, the drawings are only schematic illustrations of the present disclosure and are not necessarily drawn to scale. The same reference signs in the drawings represent the same or similar parts, and thus their repeated descriptions will be omitted. Some of the block diagrams shown in the drawings are functional entities and do not necessarily correspond to physically or logically independent entities. These functional entities may be implemented in software form, or in one or more hardware modules or integrated circuits, or in different networks and/or processor apparatuses and/or microcontroller apparatuses.

The specific implementations of the embodiments of the present disclosure will be described in detail below in conjunction with the accompanying drawings.

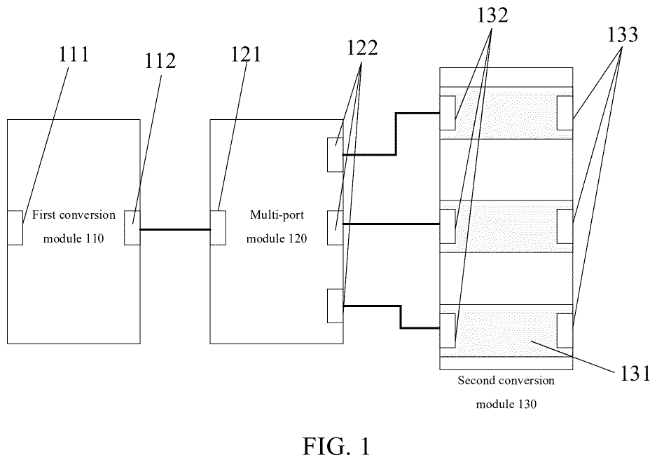

In the related art, AC-DC converters generally adopt a two-stage architecture. As shown in FIG. 1, the front-stage Power Factor Correction (PFC) circuit can simultaneously realize the phase correction of the input current and improve the sinusoidality of the input current. The rear-stage DC-DC converter realizes the voltage stabilization control of the output voltage or performs electrical isolation, and the front-stage and the rear-stage are independently regulated. The two-stage architecture converter has the advantages of easy four-quadrant operation of power and easy design of the rear-stage DC-DC conversion. However, in order to realize the decoupling control between the two stages, the two-stage converter usually requires a large capacitor in the middle stage for energy storage. The front-stage implementation generally requires hard switching, and the large loss of on and off causes the switching frequency to be unable to be increased, so a large inductor is required on the grid-side for filtering. All of these make it difficult to further improve the power density of the two-stage AC-DC converter.

The present disclosure provides a converter and a control method, an SST system and a control method, which at least to some extent overcome the problem that the power density of the converter in the related art is difficult to be improved.

Other features and advantages of the present disclosure will become apparent through the detailed description below, or partially learned through the practice of the present disclosure.

As shown in FIGS. 1 to 13, which show a converter provided by the embodiment of the present disclosure. As shown in FIG. 1, the converter includes:
a first conversion module 110, including a first AC port 111 and a second AC port 112, and used to convert the first AC to the second AC, or convert the second AC to the first AC;
a multi-port module 120, including a first port 121 and a plurality of second ports 122, and used to transmit the second AC; where the first port 121 is electrically connected to the second AC port 112; and
a second conversion module 130, including a plurality of second conversion subunits 131, where each of the second conversion subunits 131 includes a third AC port 132 and a first DC port 133, and the plurality of third AC ports 132 are electrically connected to the plurality of second ports 122 in a one-to-one correspondence.

The power transmitted by the second AC port 112 includes the power of a second harmonic component of the frequency of the first AC.

It should be noted that the first conversion module 110 is configured to convert the first AC into the second AC, or to convert the second AC into the first AC. For example, when one end of the converter is connected to the power grid, that is, the first AC port 111 is connected to the power-frequency AC, when the converter works in the rectification mode, the first conversion module 110 folds the power-frequency sinusoidal wave into a quasi-sine-wave; when the converter works in the inversion mode, the first conversion module 110 expands the quasi-sine-wave into the power-frequency sinusoidal wave.

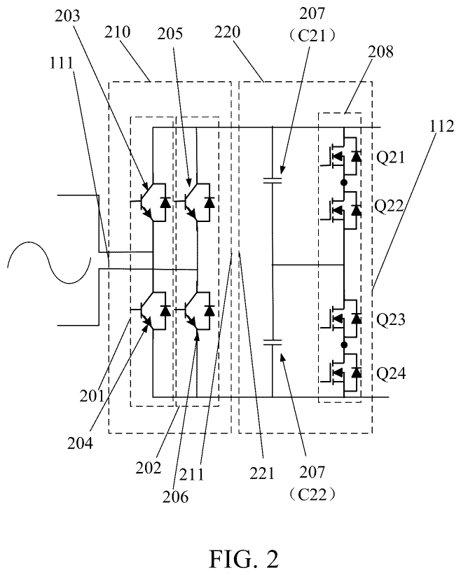

In some embodiments of the present disclosure, as shown in FIG. 2, the first conversion module 110 includes: a first conversion subunit I 210, including the first AC port 111 and a first subport 211; and a first conversion subunit II 220, including the second AC port 112 and a second subport 221.

It should be noted that the second subport 221 is electrically connected to the first subport 211. The first conversion subunit I 210 is configured to perform AC-DC or DC-AC conversion, and the first conversion subunit II 220 is configured to perform AC-DC or DC-AC conversion. In some embodiments of the present disclosure, when the working mode of the converter is the inversion mode, the first conversion subunit II 220 converts the second AC input through the second AC port 112 into the first DC, and outputs the first DC to the first subport 211 of the first conversion subunit I 210 through the second subport 221; the first conversion subunit I 210 converts the first DC input to the first subport 211 into the first AC, and outputs the first AC through the first AC port 111.

In some embodiments of the present disclosure, when the working mode of the converter is the rectification mode, the first conversion subunit 1210 converts the first AC input to the first AC port 111 into the second DC, and outputs the second DC to the first conversion subunit II 220 via the first subport 211; the first conversion subunit II 220 converts the second DC input to the second subport 221 into the second AC, and outputs the second AC via the second AC port 112.

In some embodiments of the present disclosure, as shown in FIG. 2, the first conversion subunit I 210 includes: a first conversion bridge arm 201 and a second conversion bridge arm 202, the first conversion bridge arm 201 and the second conversion bridge arm 202 are electrically connected in parallel; the midpoint of the first conversion bridge arm 201 and the midpoint of the second conversion bridge arm 202 constitute the first AC port 111. It should be noted that the current flow direction of the first conversion bridge arm 201 is opposite to the current flow direction of the second conversion bridge arm 202.

It can be understood by those skilled in the art that the first conversion subunit I 210 is configured to perform mutual conversion between direct current and alternating current. The specific structure is not limited here. For example, as shown in FIG. 2, the first conversion bridge arm 201 and the second conversion bridge arm 202 each may include two switching transistors, that is, the first conversion bridge arm 201 includes a first conversion switching transistor I 203 and a first conversion switching transistor II 204 connected in series; the second conversion bridge arm 202 includes a first conversion switching transistor III 205 and a first conversion switching transistor IV 206 connected in series. It can also be that the first conversion bridge arm 201 and the second conversion bridge arm 202 each include two diodes, which is not elaborated in the embodiments of the present disclosure.

In some embodiments of the present disclosure, as shown in FIG. 2, the first conversion subunit II 220 includes: at least one first conversion capacitor I 207 and a first conversion circuit 208 connected in parallel with at least one first conversion capacitor I 207. It should be noted that the capacitance value of the first conversion capacitor I 207 is extremely small, does not store energy, and only plays the role of filtering the switch ripple, so that the power transmitted by the second AC port 112 includes the power of the second harmonic component of the frequency of the first AC.

As shown in FIGS. 2 to 5, several implementations of the first conversion subunit II 220 are shown.

As shown in FIG. 2, it is a first schematic diagram of a circuit structure of the first conversion subunit II 220 in an exemplary embodiment, specifically including: a capacitor C21, a capacitor C22, a switching transistor Q21, a switching transistor Q22, a switching transistor Q23, and a switching transistor Q24, the switching transistor Q21 and the switching transistor Q22 are connected in series and then connected in parallel with the capacitor C21, and the switching transistor Q23 and the switching transistor Q24 are connected in series and then connected in parallel with the capacitor C22. The second end of capacitor C21 is connected to the first end of capacitor C22, and the second end of the switching transistor Q22 is connected to the first end of switching transistor Q23. The connection point of the switching transistor Q21 and the switching transistor Q22 is one end of the second AC port 112, and the connection point of the switching transistor Q23 and the switching transistor Q24 is the other end of the second AC port 112.

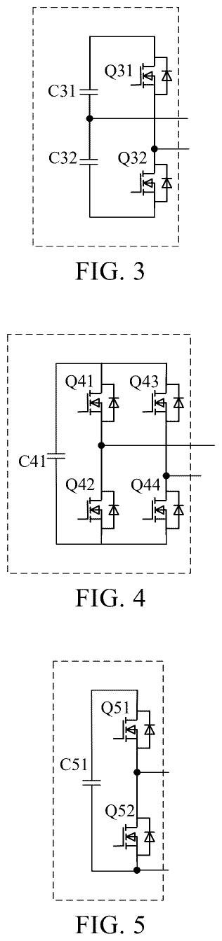

As shown in FIG. 3, it is a second schematic diagram of the circuit structure of the first conversion subunit II 220 in the exemplary embodiment, specifically including: a capacitor C31, a capacitor C32, a switching transistor Q31 and a switching transistor Q32. The capacitor C31 and capacitor C32 are connected in series to form a first series branch, the switching transistor Q31 and the switching transistor Q32 are connected in series to form a second series branch, and the first series branch and the second series branch are connected in parallel. The connection point of the capacitor C31 and the capacitor C32 is one end of the second AC port 112, and the connection point of the switching transistor Q31 and the switching transistor Q32 is the other end of the second AC port 112.

As shown in FIG. 4, it is a third schematic diagram of the circuit structure of the first conversion subunit II 220 in the exemplary embodiment, specifically including: a capacitor C41, and switching transistors Q41, Q42, Q43 and Q44. The switching transistors Q41 and Q42 are connected in series to form a third series branch, the switching transistors Q43 and Q44 are connected in series to form a fourth series branch, and the third series branch, the fourth series branch and the capacitor C41 are connected in parallel. The connection point of the switching transistors Q41 and Q42 is one end of the second AC port 112, and the connection point of the switching transistors Q43 and Q44 is the other end of the second AC port 112.

As shown in FIG. 5, it is a fourth schematic diagram of the circuit structure of the first conversion subunit II 220 in the exemplary embodiment, specifically including: a capacitor C51, and switching transistors Q51 and Q52. The switching transistors Q51 and Q52 are connected in series, and then connected in parallel with the capacitor C51, the connection point of the switching transistors Q51 and Q52 is one end of the second AC port 112, and the second end of the switching transistor Q52 is the other end of the second AC port 112.

In some other embodiments of the present disclosure, the first conversion module 110 includes: a first conversion subunit III. The first conversion subunit III is configured to convert between the first alternating current and the second alternating current.

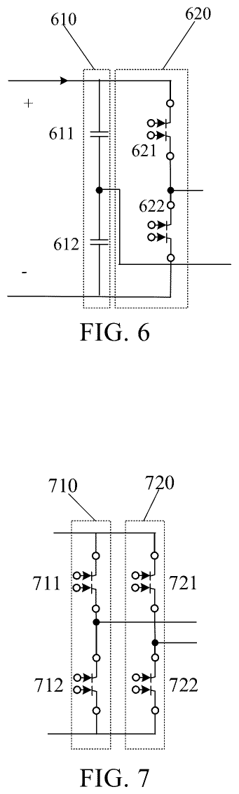

As shown in FIG. 6 to FIG. 7, there are several implementations of the first conversion subunit III.

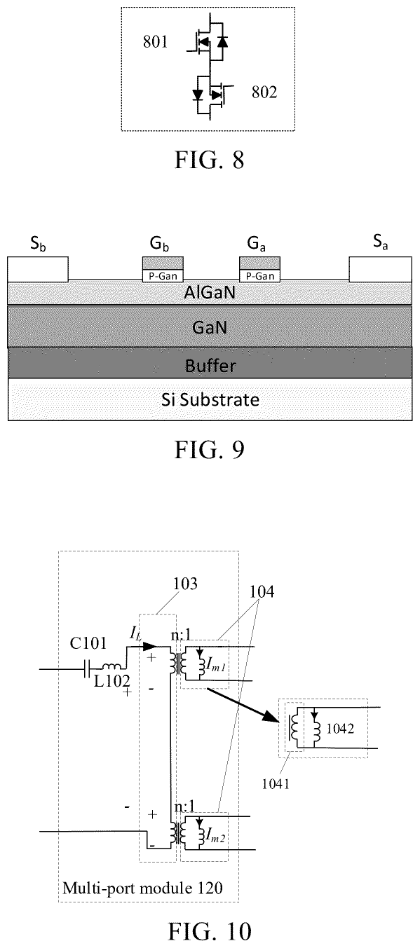

In some embodiments of the present disclosure, the first conversion subunit III includes a first bridge circuit. As shown in FIG. 6, it is a schematic diagram of the circuit structure of the first bridge circuit, which specifically includes: a first bridge arm 610 and a second bridge arm 620. The first bridge arm 610 of the first bridge circuit includes two first bridge capacitors (611, 612) connected in series; the second bridge arm 620 of the first bridge circuit includes two first bridge bidirectional switches (621, 622) connected in series; the midpoint of the first bridge arm 610 of the first bridge circuit and the midpoint of the second bridge arm 620 of the first bridge circuit constitute the second AC port 112. It can be understood by those skilled in the art that the first bridge bidirectional switch can also be replaced by a structure of two unidirectional switches connected in reverse series, as shown in FIG. 8, including two unidirectional switches 801 and 802 connected in series in two directions.

In some embodiments of the present disclosure, the first conversion subunit III includes a second bridge circuit. As shown in FIG. 7, it is a schematic diagram of the circuit structure of the second bridge circuit, which specifically includes: a first bridge arm 710 and a second bridge arm 720. The first bridge arm 710 of the second bridge circuit includes a second bridge active switch I 711 and a second bridge active switch II 712 connected in series; the second bridge arm 720 of the second bridge circuit includes a second bridge active switch III 721 and a second bridge active switch IV 722 connected in series, and the midpoint of the first bridge arm 710 of the second bridge circuit and the midpoint of the second bridge arm 720 of the second bridge circuit constitute the second AC port 112.

It should be noted that the above-mentioned first bridge bidirectional switch 621, the first bridge bidirectional switch 622, the second bridge active switch I 711, the second bridge active switch II 712, the second bridge active switch III 721 and the second bridge active switch IV 722 can adopt an integrated bidirectional switch as shown in FIG. 9.

It should be noted that the integrated bidirectional switch shown in FIG. 9 includes: a Si Substrate (silicon substrate), a Buffer (buffer layer) used to improve material quality, reduce defects, and improve device performance, a GaN (gallium nitride layer), an AlGaN (aluminum gallium nitride layer), a P-Gan (doped gallium nitride layer), Source contacts, respectively marked as Sₐ and S_{b}, which are the main paths for current to flow into and out of the device, and Gate contacts, respectively marked as Gₐ and G_{b}, which are used to control the conduction state of the device.

It should be noted that the capacitors included in the first conversion module 110 are all capacitors with extremely small capacitance values, which do not store energy and only play the role of filtering switching ripples.

It should be noted that the multi-port module 120 is configured to transmit the second alternating current. Specifically, when the converter works in the rectification mode, the second alternating current is transmitted from the first conversion module 110 to the second conversion module 130; when the converter works in the inversion mode, the second alternating current is transmitted from the second conversion module 130 to the first conversion module 110.

In some embodiments of the present disclosure, the multi-port module 120 includes a transformer; the transformer includes a primary winding branch and multiple secondary winding branches, and the number of the secondary winding branches is equal to the number of the second ports 122. The secondary winding branch includes: a secondary winding and an excitation inductor, and the secondary winding and the excitation inductor are connected in parallel.

As shown in FIG. 10, it is a circuit structure diagram of the multi-port module 120 in some embodiments of the present disclosure. The multi-port module 120 is an LLC circuit, specifically including: a capacitor C101, an inductor L102, a primary winding branch 103, and multiple secondary winding branches 104, each secondary winding branch includes a secondary winding 1041 and an excitation inductor 1042 connected in parallel.

In some embodiments of the present disclosure, the second conversion module 130 includes a plurality of second conversion subunits 131, each of which receives or outputs the second alternating current using the third AC port 132, and receives or outputs the direct current using the first DC port 133, and each of which is configured to convert between the second alternating current and the direct current, that is, to perform AC-DC or DC-AC conversion. For example, when the converter operates in the rectification mode, each second conversion subunit 131 converts the input second alternating current into direct current and outputs it via the first DC port 133; when the converter operates in the inversion mode, each second conversion subunit 131 converts the input direct current into the second alternating current and outputs it via the third AC port 132 to the multi-port module 120 for transmission.

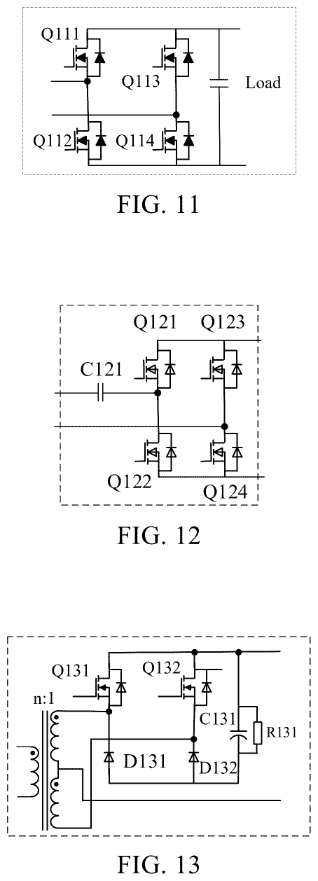

As shown in FIGS. 11 to 13, several implementations of the second conversion subunit 131 in the embodiments of the present disclosure are shown.

As shown in FIG. 11, it is a first schematic diagram of a circuit structure of the second conversion subunit 131 in the exemplary embodiment, which is a full-bridge circuit, specifically including: switching transistors Q111, Q112, Q113 and Q114, where the switching transistors Q111 and Q112 form one bridge arm, and the switching transistors Q113 and Q114 form another bridge arm, and the midpoints of the two bridge arms are respectively connected to the two ends of the secondary winding branch, and the two bridge arms are connected in parallel and then output.

As shown in FIG. 12, it is a second schematic diagram of the circuit structure of the second conversion subunit 131 in the exemplary embodiment, which specifically includes: a capacitor C121, switching transistors Q121, Q122, Q123 and Q124, where the switching transistors Q121 and Q122 form one bridge arm, and the switching transistors Q123 and Q124 form another bridge arm. The midpoint of one bridge arm is connected to one end of the secondary winding branch, and the midpoint of the other bridge arm is connected in series with the capacitor C121 and then connected to the other end of the secondary winding branch. The two bridge arms are connected in parallel and then output.

As shown in FIG. 13, it is a third schematic diagram of the circuit structure of the second conversion subunit 131 in the exemplary embodiment, specifically including: a capacitor C131, a resistor R131, switching transistors Q131, Q132, diodes D131, D132, the switching transistor Q131 and the diode D131 form one bridge arm, the switching transistor Q132 and the diode D132 form another bridge arm, and the midpoints of the two bridge arms are respectively connected to the two ends of the secondary winding branch. The capacitor C131 and the resistor R131 are connected in parallel to form a parallel branch, and the two bridge arms and the parallel branch are connected in parallel as one end of the first DC port 133, and the midpoint lead of the secondary winding serves as the other end of the first DC port 133.

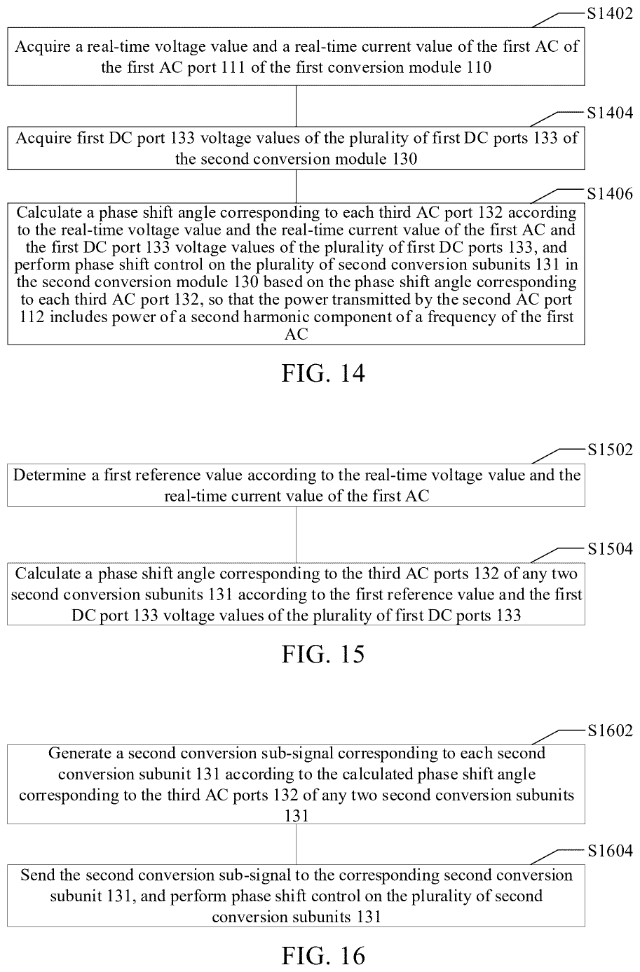

For the converter shown in FIGS. 1 to 13 above, the embodiment of the present disclosure provides a control method, as shown in FIG. 14, including the following steps.
In S1402, a real-time voltage value and a real-time current value of the first AC of the first AC port 111 of the first conversion module 110 are acquired.
In S1404, first DC port 133 voltage values of the plurality of first DC ports 133 of the second conversion module 130 are acquired.
In S1406, a phase shift angle corresponding to each third AC port 132 is calculated according to the real-time voltage value and the real-time current value of the first AC and the first DC port 133 voltage values of the plurality of first DC ports 133, and phase shift control is performed on the plurality of second conversion subunits 131 in the second conversion module 130 based on the phase shift angle corresponding to each third AC port 132, so that the power transmitted by the second AC port 112 includes the power of the second harmonic component of the frequency of the first AC.

In some embodiments of the present disclosure, the implementation process of calculating the phase shift angle corresponding to each third AC port 132 according to the real-time voltage value and the real-time current value of the first AC and the first DC port 133 voltage value of the plurality of first DC ports 133, as shown in FIG. 15, includes the following steps.
In S1502, a first reference value is determined according to the real-time voltage value and the real-time current value of the first AC.
In S1504, a phase shift angle corresponding to the third AC ports 132 of any two second conversion subunits 131 is calculated according to the first reference value and the first DC port 133 voltage values of the plurality of first DC ports 133.

It should be noted that the first reference value refers to the voltage reference value and the current reference value of the first AC, and the current reference value of the first AC refers to the grid-side current instruction generated by the grid-side power demand and the phase of the grid-side voltage. The voltage reference value of the first AC can be calculated according to the following formula:

$${V}_{bRef} = - ( {I}_{gRef} - {i}_{g} ) \times {K}_{p} + {V}_{g} \qquad ( 1 )$$

where V_{bRef} represents the voltage reference value of the first alternating current; I_{gRef} represents the current reference value of the first alternating current; i_{g} represents the real-time current value of the first alternating current; V_{g} represents the real-time voltage value of the first alternating current; Kₚ represents the first control coefficient, which is a constant.

In some embodiments of the present disclosure, the phase shift angle corresponding to the third AC ports 132 of any two second conversion subunits 131 is calculated according to the following formula:

$$Δ φ 1 = π - 2 arcsin ( \frac{abs ( {V}_{bRef} )}{2 ( {nV}_{Oa} + {nV}_{Ob} )} ) \qquad ( 2 )$$

where Δφ1 represents the phase shift angle corresponding to the third AC ports 132 of the two second conversion subunits numbered a and b; n represents the transformer ratio; Vₒₐ represents the voltage value of the first DC port 133 of the second conversion subunit numbered a; V_{ob} represents the voltage value of the first DC port 133 of the second conversion subunit numbered b.

In some embodiments of the present disclosure, the implementation process of phase shift control of multiple second conversion subunits 131 in the second conversion module 130 based on the phase shift angle corresponding to each third AC port 132, as shown in FIG. 16, includes the following steps.
In S1602, a second conversion sub-signal corresponding to each second conversion subunit 131 is generated according to the calculated phase shift angle corresponding to the third AC ports 132 of any two second conversion subunits 131.
In S1604, the second conversion sub-signal is sent to the corresponding second conversion subunit 131, and phase shift control is performed on the plurality of second conversion subunits 131.

It should be noted that, based on the above formulas (1) and (2), the phase shift angle corresponding to the third AC ports 132 of any two second conversion subunits 131 can be calculated, and based on this, the second conversion sub-signal corresponding to each second conversion subunit 131 can be generated, and the second conversion sub-signal is sent to the corresponding second conversion subunit 131, that is, the PWM signal, to control the on or off of the switching transistor in each second conversion subunit 131.

It can be understood that the converter provided in the embodiments of the present disclosure can work in both the inversion mode and the rectification mode.

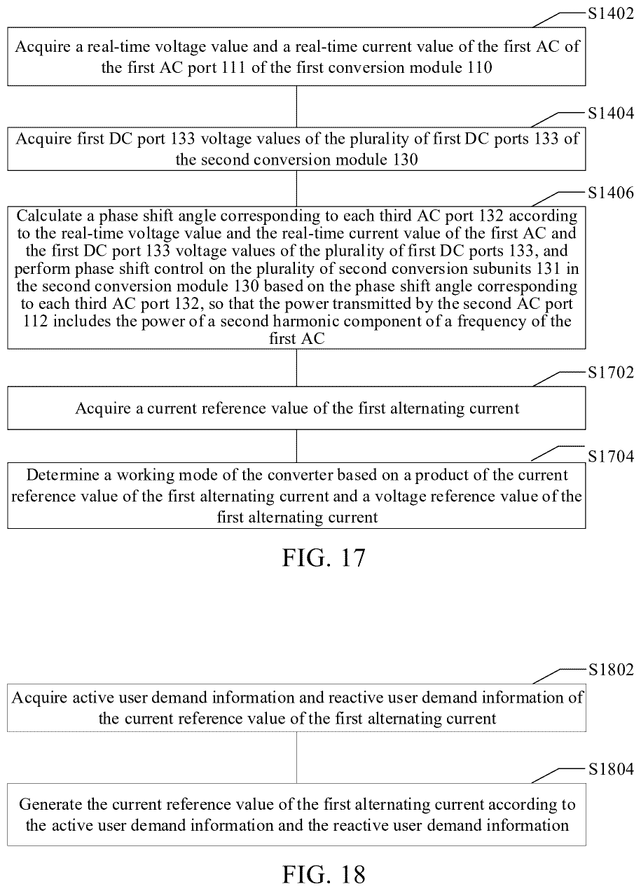

Accordingly, a control method for a converter provided in the embodiment of the present disclosure, as shown in FIG. 17, further includes the following steps based on FIG. 14.
In S1702, a current reference value of the first alternating current is acquired.
In S1704, a working mode of the converter is determined based on a product of the current reference value of the first alternating current and a voltage reference value of the first alternating current.

It should be noted that the working mode of the converter is determined based on the positive or negative value of the product value of the current reference value of the first alternating current and the voltage reference value of the first alternating current. When the product value is less than 0, the working mode of the converter is the inversion mode, and when the product value is greater than 0, the working mode of the converter is the rectification mode.

In some embodiments of the present disclosure, the implementation process of acquiring the current reference value of the first alternating current, as shown in FIG. 18, includes the following steps.
In S1802, active user demand information and reactive user demand information of the current reference value of the first alternating current are acquired.
In S1804, the current reference value of the first alternating current is generated according to the active user demand information and the reactive user demand information.

It should be noted that the active user demand information of the current reference value of the first alternating current refers to the size of the active power or the amplitude of the active current required by the user, and the reactive user demand information of the current reference value of the first alternating current refers to the size of the reactive power or the amplitude of the reactive current required by the user. Based on the active user demand information and the reactive user demand information, the current reference value of the first alternating current that meets the demand information can be generated.

In some exemplary embodiments of the present disclosure, when it is determined that the working mode of the converter is the rectification mode, the control method for the converter further includes: controlling the first conversion subunit I 210 to convert the first AC input to the first AC port 111 into the second DC, and output the second DC to the first conversion subunit II 220 via the first subport 211; controlling the first conversion subunit II 220 to convert the second DC input to the second subport 221 into the second AC, and output the second AC via the second AC port 112.

In some exemplary embodiments of the present disclosure, when it is determined that the working mode of the converter is the rectification mode, the control method for the converter further includes: controlling the second conversion subunit 131 to convert the AC input to the third AC port 132 into the DC of the first port 121, and output it via the first DC port 133.

In some exemplary embodiments of the present disclosure, when it is determined that the working mode of the converter is the rectification mode, the control method for the converter further includes: determining the real-time current value of the first alternating current; calculating a turn-off lag angle of each second conversion subunit 131 compared with the first conversion subunit II 220 according to the real-time current value of the first alternating current, the current reference value of the first alternating current, and the first DC port 133 voltage values of the plurality of first DC ports 133 of the second conversion module 130; and controlling the turn-off of the plurality of second conversion subunits 131 based on the turn-off lag angle of each second conversion subunit 131 compared with the first conversion subunit II 220.

It should be noted that when the working mode of the converter is the rectification mode, the plurality of second conversion subunits 131 are in a synchronous operation mode, that is, the driving is exactly the same, and the switching transistors in the plurality of second conversion subunits 131 are turned off later than the switching transistors in the first conversion subunit II 220, so as to achieve the purpose of boosting.

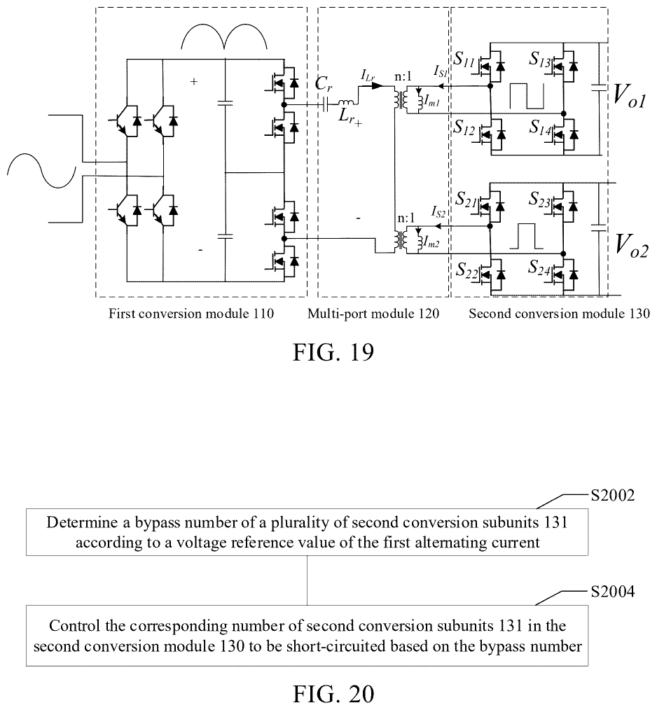

In some embodiments of the present disclosure, a converter as shown in FIG. 19 is provided, including two second conversion subunits 131, numbered 1 and 2, respectively, and the voltage values of the corresponding first DC ports 133 are Vₒ₁ and Vₒ₂, respectively.

The turn-off lag angle of each second conversion subunit compared to the first conversion subunit II 220 can be calculated according to the following formula:

$$Δ ϕ 2 = arccos \frac{1 + \frac{{I}_{gRef}}{4 {C}_{r} {fV}_{dcRef}} ( \frac{2 abs ( {V}_{bRef} )}{( {nV}_{O 1} + {nV}_{O 2} )} - 1 )}{1 + \frac{{I}_{gRef}}{4 {C}_{r} {fV}_{dcRef}}} \qquad ( 3 )$$

where V_{bRef} represents the voltage reference value of the first alternating current, which can be determined by formula (1); I_{gRef} represents the current reference value of the first alternating current; Cᵣ represents the capacitance of the resonant capacitor in the LLC circuit in the multi-port module; f represents the switching frequency corresponding to the first conversion subunit II; V_{dcRef} represents the voltage command value at the connection between the first conversion subunit I and the first conversion subunit II, which is calculated by the grid-side current closed-loop control; n represents the transformer ratio.

In some exemplary embodiments of the present disclosure, when it is determined that the working mode of the converter is the inversion mode, the control method for the converter further includes: controlling the first conversion subunit II 220 to convert the second alternating current input through the second AC port 112 into the first direct current, and output the first direct current to the first subport 211 of the first conversion subunit I 210 through the second subport 221; controlling the first conversion subunit I 210 to convert the first direct current input to the first subport 211 into the first alternating current, and output the first alternating current through the first AC port 111.

In some exemplary embodiments of the present disclosure, when it is determined that the working mode of the converter is the rectification mode, the control method for the converter further includes: controlling the first conversion subunit III to convert the first AC input to the first AC port 111 into the second AC, and output the second AC through the second AC port 112.

In some exemplary embodiments of the present disclosure, when it is determined that the working mode of the converter is the inversion mode, the control method for the converter further includes: controlling the first conversion subunit III to convert the second AC input to the second AC port 112 into the first AC, and output the first AC through the first AC port 111.

In some exemplary embodiments of the present disclosure, when it is determined that the working mode of the converter is the inversion mode, the control method for the converter further includes: controlling the second conversion subunit 131 to convert the DC power of the first port 121 input to the first DC port 133 into AC power, and output the AC power through the third AC port 132.

It should be noted that when the converter works in the inversion mode, the switching transistor in the first conversion module 110 performs power-frequency operation according to the grid-side voltage to expand the second alternating current in the quasi-sine-wave style transmitted by the second AC port 112 into the first alternating current in the sine wave style.

It should be noted that since the converter includes multiple second conversion subunits 131, during operation, some of the second conversion subunits 131 can be put into use, rather than all of the second conversion subunits 131 being in working state, that is, multiple second conversion subunits 131 can be bypassed.

Accordingly, in some exemplary embodiments of the present disclosure, a control method for a converter is provided, as shown in FIG. 20, including the following steps.
In S2002, a bypass number of a plurality of second conversion subunits 131 is determined according to a voltage reference value of the first alternating current.
In S2004, based on the bypass number, the corresponding number of second conversion subunits 131 in the second conversion module 130 are controlled to be short-circuited.

It should be noted that controlling the second conversion subunit 131 to be short-circuited means short-circuiting the secondary side of the transformer corresponding to the second conversion subunit 131. The short-circuiting method can be to turn on the upper switches of the two bridge arms at the same time, or to turn on the lower switches of the two bridge arms at the same time.

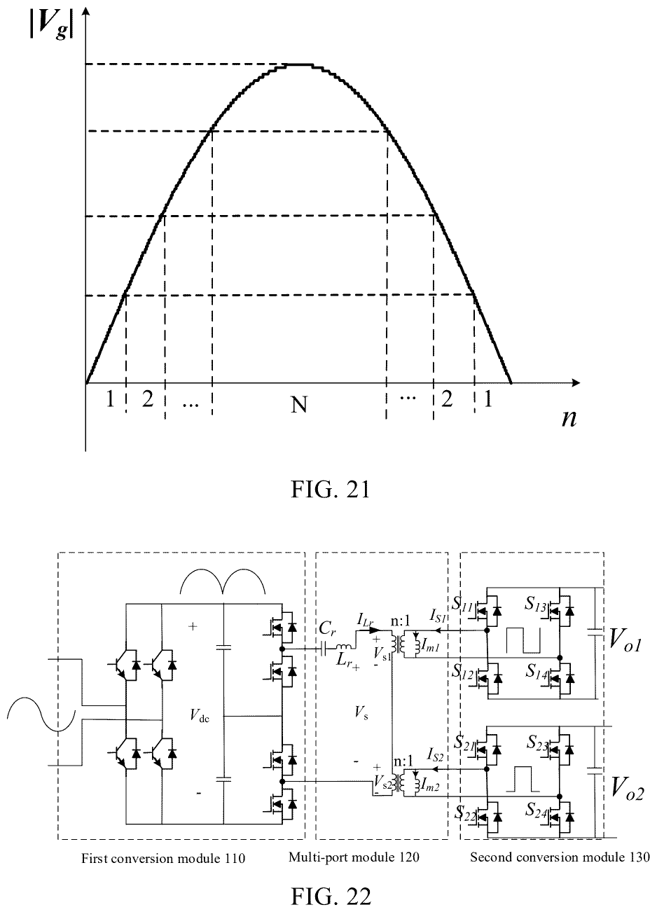

In some embodiments of the present disclosure, the bypass number is negatively correlated with the absolute value of the voltage reference value of the first alternating current. As shown in FIG. 21, it is the correlation between the number n of the second conversion subunits 131 put into operation and the absolute value |V_{g}| of the voltage reference value of the first alternating current, where N is an integer greater than 2. It can be seen from the figure that the lower the absolute value of the voltage reference value of the first alternating current, the more the bypass number of the second conversion subunit 131. By bypassing the second conversion subunit 131, a new degree of freedom is provided for changing the gain of the converter, which reduces the boost pressure when the converter works in the rectification mode.

It should be noted that when the converter works in the inversion mode, the bypass number of multiple second conversion subunits 131 can also be determined according to the voltage reference value of the first alternating current, and the corresponding number of second conversion subunits 131 in the second conversion module 130 can be controlled to short-circuit based on the bypass number. By bypassing one or more second conversion subunits 131, the non-bypassed second conversion subunit(s) can be made to work in an interval with small voltage gain, thereby improving the conversion efficiency of the second conversion subunit and improving the conversion efficiency of the entire system.

In order to better illustrate the converter provided by the embodiments of the present disclosure and the control method applied to the converter, a specific example is provided for further explanation.

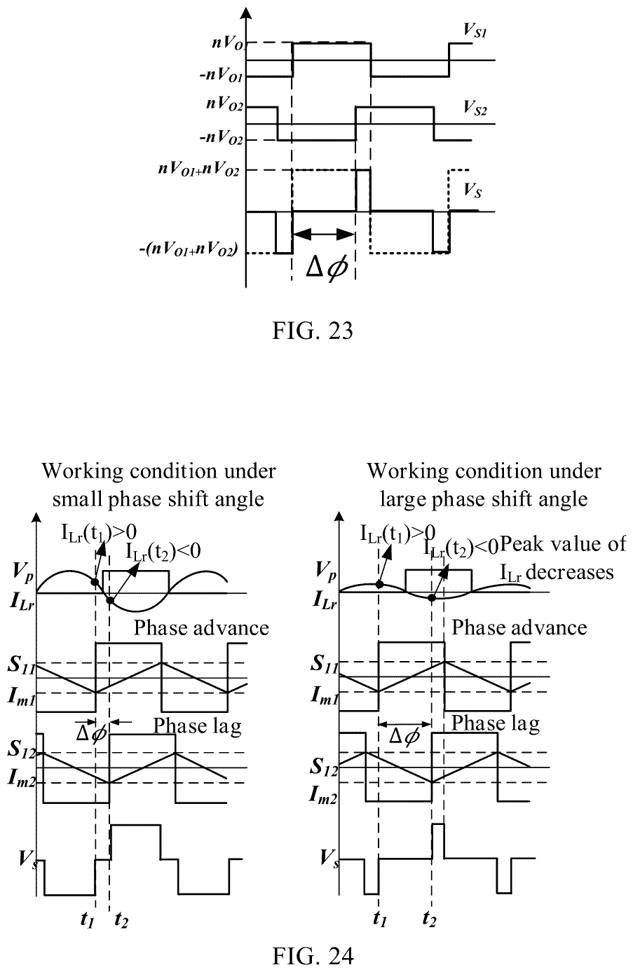

As shown in FIG. 22, it is a converter in this specific example. The converter includes two second conversion subunits 131 (numbered 1 and 2 for the sake of simplicity in the subsequent description). When the converter works in the inversion mode, the second conversion module 130 of the converter needs to achieve a wide-range voltage reduction, each second conversion subunit generates waves at a fixed switching frequency, and phase shift control is performed between the second conversion subunits, so that the second AC is a quasi-sine-wave. Its basic principle is shown in FIG. 23, where Vs1 and Vs2 correspond to the voltages of the second AC corresponding to the second conversion subunit 1 and the second conversion subunit 2 respectively (converted to the primary winding side of the transformer), and are formed by the active generation of waves by respective second conversion subunits 131. If the phase shift is performed between the second conversion subunits 131, after the primary windings of the transformer are connected in series, a three-level step wave as shown in Vs in FIG. 23 may be formed at the series port. Compared with the square wave formed without phase shift between the second conversion subunits 131, the fundamental wave content of the three-level step wave is lower, which is

$$\frac{4}{π} ( sin \frac{π - Δ ϕ}{2} ) ( {nV}_{o 1}^{′} + {nV}_{o 2}^{′} ) ,$$

where Δφ is the phase shift angle between the two second conversion subunits, n is the transformer ratio, and Vₒ₁′ and Vₒ₂′ represent the output voltages of the second conversion subunit 1 and the second conversion subunit 2. It can be seen that the voltage reduction control of the second conversion module 130 at the subsequent stage can be achieved by adjusting the phase shift angle.

When the converter works in the inversion mode, the full range Zero Voltage Switching (ZVS) control of the second conversion subunit can be realized. The principle is shown in FIG. 24. On the one hand, the condition for the SN1 diode of the second conversion subunit at the secondary side of the latter stage to realize the ZVS is i_{sN}<0 (N is the module number), where I_{sN}(t)=I_{mN}(t)−nl_{Lr}(t). The excitation inductance of the transformer of each second conversion subunit is independent, and the negative peak of the excitation current I_{mN} corresponds to the moment when the switching transistor acts, which can help the corresponding second conversion subunit realize ZVS. On the other hand, the magnitude of I_{Lr} at the moment when the switching transistor acts is related to the magnitude of the active power of the converter and the magnitude of the phase shift angle between the second conversion subunits, and usually, when the advance second conversion subunit acts, I_{Lr}>0, so it is easy for the advance second conversion subunit to meet the condition of i_{sN}<0, thus realizing ZVS; however, when the lag second conversion subunit acts, I_{Lr}<0, so it is more difficult for the lag second conversion subunit to meet the condition of i_{sN}<0. However, the AC-DC converter has one characteristic: the instantaneous power is small when the network side voltage is low, and the instantaneous power is large when the network side voltage is high. The requirements corresponding to the latter stage are: when the power is high, the voltage gain is narrow, that is, the phase shift angle is small; and when the power is small, the gain range is wide, that is, the phase shift angle is large. That is, when the phase shift angle is large, although I_{Lr} is greater than 0, its amplitude is very small, so the lag second conversion subunit can realize ZVS by I_{mN}.

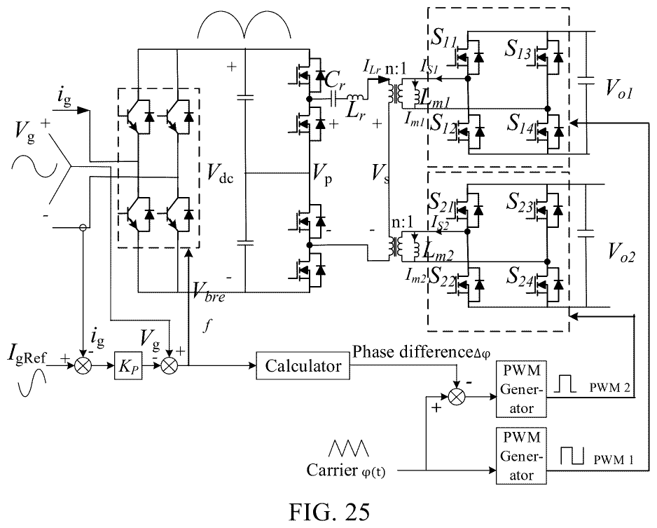

Based on the control method provided in the embodiments of the present disclosure, simulation is performed when the converter operates in the inversion mode. The control block diagram is shown in FIG. 25, where I_{gRef} is a grid-side current command generated according to the grid-side power demand and the phase of the grid-side voltage, and two second conversion subunits emit waves at the same switching frequency. By closed-loop regulation of the grid-side current Ig, a virtual V_{bRef} voltage is generated, and then the phase shift angle between the second conversion subunits is generated according to formula (2) to achieve voltage reduction control in the inversion mode.

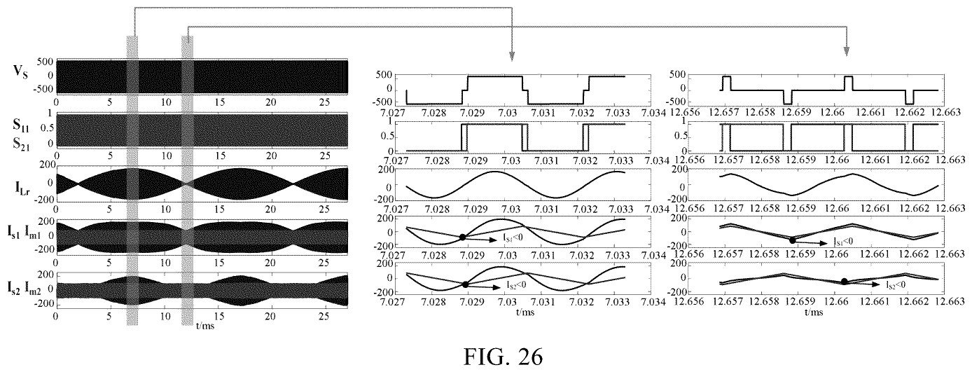

As shown in FIG. 26, which is a simulated waveform diagram, it can be seen that the converter can achieve full range ZVS in the inversion mode.

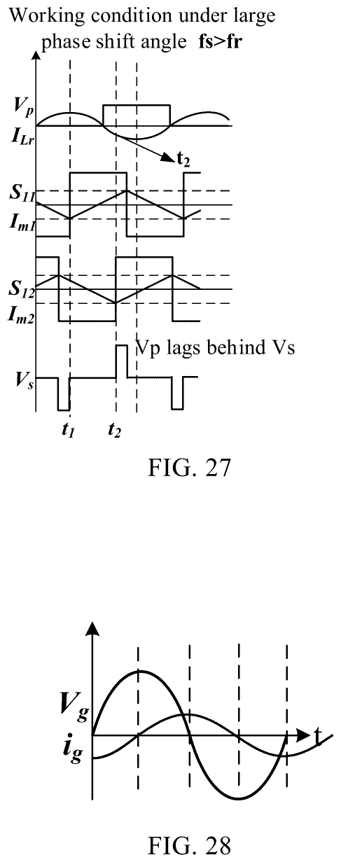

It should be noted that the switching frequency fs of the two second conversion subunits mentioned above may be the resonant frequency fr of LLC, or slightly deviate from the resonant frequency. Taking fs slightly larger than fr as an example, it is more advantageous for the lagging bridge arm to achieve ZVS when the voltage drop range is large. The principle is shown in FIG. 27. When fs>fr, the resonant cavity of LLC is inductive, so Vp lags behind Vs. It can be seen that the t₂ moment shifts to the left and ILr(t2) becomes smaller, which is more conducive to the lagging bridge arm to achieve ZVS. This will cause the action time of the switching transistor of the lagging bridge arm to move closer to the zero crossing point of I_{Lr}, making it easier to achieve ZVS.

Specifically, the inverter that operates in reverse usually requires reactive power generation, which is difficult to be achieved by single-stage converters because generating reactive power means that the inverter needs to have the ability to operate in both forward and reverse directions of power. As shown in FIG. 28, the converter needs to complete 4 power forward and reverse switching cycles within one power-frequency cycle.

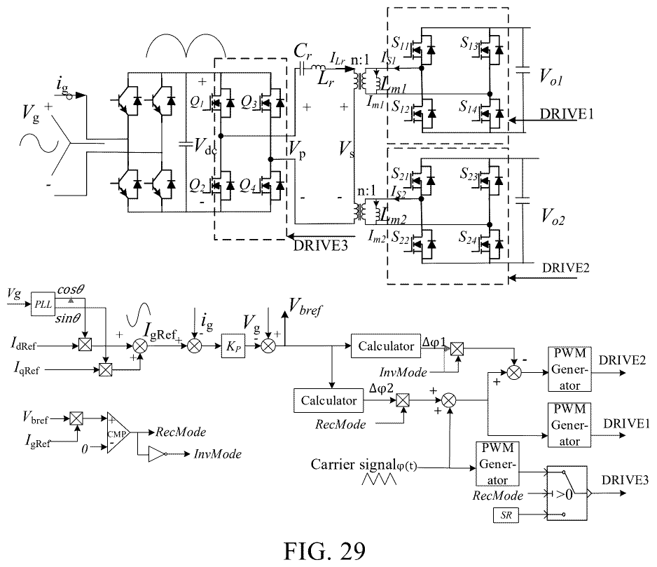

The reactive power generation of the converter provided in this specific example can adopt the control logic shown in FIG. 29, including: the converter generating a reference I_{gRef} of the grid-side current i_{g} according to the user's active and reactive current requirements, then performing closed-loop control on i_{g}, and then generating a reference V_{bRef}Of the grid-side bridge arm voltage Vb. The product of V_{bRef} and I_{gRef} determines whether the converter operates in the rectification mode (RecMode) or the inversion mode (InvMode).

When the converter operates in the rectification mode, the diode in the first conversion module 110 perform rectification operation, and the two second conversion subunits of the subsequent LLC are in a synchronous operation mode, i.e., they are driven identically. The switching tubs of the two second conversion subunits lag behind the switching transistor of the primary side of the LLC in turning-off, thereby achieving the purpose of boosting the voltage. The lag angle can be calculated by open-loop calculation using formula (3).

When the converter operates in the inversion mode, the switching tub in the first conversion module 110 performs power-frequency operation according to the grid-side voltage, with the purpose of expanding the quasi-sine-wave of V_{dc} into a sine wave.

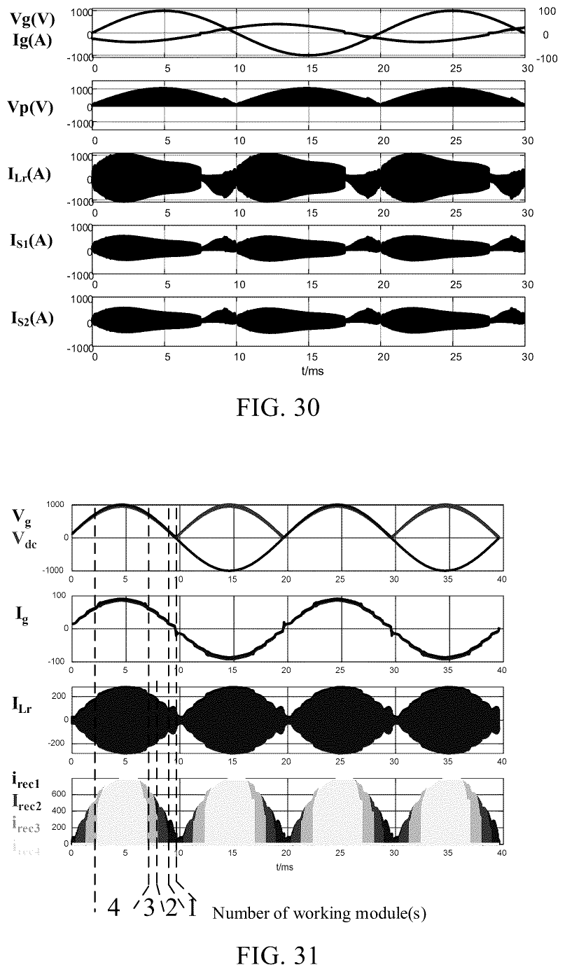

The simulated waveform of the reactive power generation condition is shown in FIG. 30. It can be seen that the present disclosure can achieve rapid switching between the inversion mode and the rectification mode, thereby ensuring the sinusoidality of the grid-side current waveform.

Furthermore, the converter provided in this specific example can also perform bypass control during forward operation. As shown in FIG. 21, the number of second conversion subunits to be bypassed is selected according to a reference value of the AC-side bridge arm voltage required for control (this value is very close to the AC-side grid voltage). The simulation results of operation after the corresponding bypass control are shown in FIG. 31, where i_{rec1}, i_{rec2}, i_{rec3}, and i_{rec4} represent the output currents of the second conversion subunits numbered 1, 2, 3, and 4, respectively. This indicates that bypassing the second conversion subunits can help achieve Power Factor Correction (PFC) functionality.

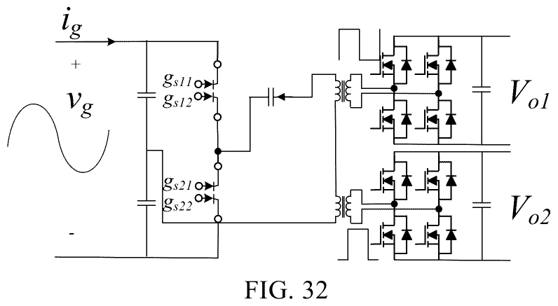

As shown in FIG. 32, it is an implementation circuit of this specific example using a bidirectional switch. When the converter operates in the rectification mode, if the grid-side voltage is greater than 0, the lower transistors (gₛ₁₂ and gₛ₂₂) of the bidirectional switch are normally closed, and the upper transistors (gₛ₁₁ and gₛ₂₁) actively generate waves. If the grid-side voltage is less than or equal to 0, the upper transistors (gₛ₁₁ and gₛ₂₁) of the bidirectional switch are normally closed, and the lower transistors (gₛ₁₂ and gₛ₂₂) actively generate waves. When the converter operates in the inversion mode, if the grid-side voltage is greater than 0, the lower transistors (gₛ₁₂ and gₛ₂₂) of the bidirectional switch are normally closed, and the upper transistors (gₛ₁₁ and gₛ₂₁) follow the LLC secondary side for synchronous rectification. If the grid-side voltage is less than or equal to 0, the upper transistors (gₛ₁₁ and gₛ₂₁) of the bidirectional switch are normally closed, and the lower transistors (gₛ₁₂ and gₛ₂₂) follow the LLC secondary side for synchronous rectification.

As can be seen from the structure and control method of the above-described converter, this specific example utilizes a single-stage topology to implement a high-power-density AC-DC converter; through the interaction among a plurality of second conversion sub-units, more flexible control can be achieved; and when the converter operates in the inversion mode, a wide-range voltage reduction can be achieved, and when it operates in the rectification mode, a wide-range voltage boost can be achieved, and full-range ZVS can be achieved.

Based on the same inventive concept, the embodiments of the present disclosure also provide a solid-state transformer (SST) system, as described in the following embodiments. Since the principle of the SST system embodiment for solving the problem is similar to that of the above-described control method and converter embodiments, the implementation of the SST system embodiment can refer to the implementation of the above-described control method and converter embodiments, and any repetitive details will not be repeated.

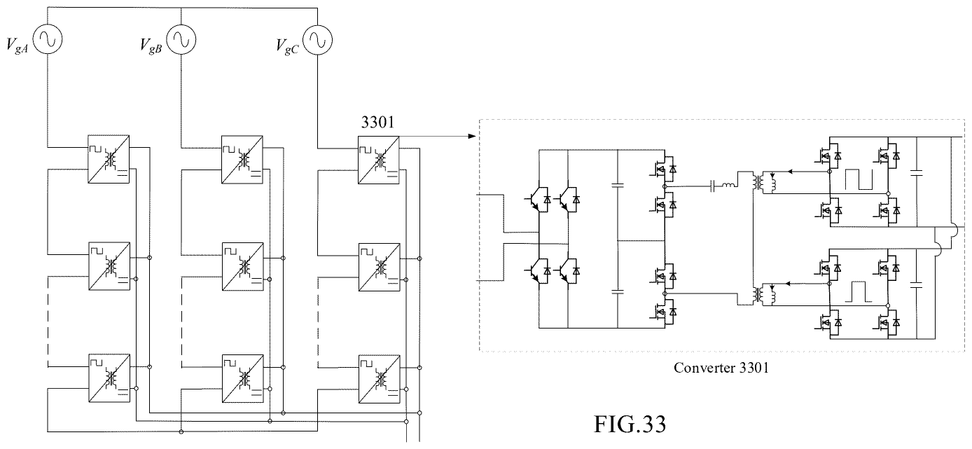

As shown in FIG. 33, each phase of the SST system includes a plurality of the converters 3301 as described in the above embodiments, and each converter includes a first end and a second end;
the first ends of the plurality of converters in each phase of the SST system are sequentially connected in series and then connected to a same phase AC power supply; and
the second ends of the plurality of converters in each phase of the SST system are electrically connected to form an output end of each phase of the SST system.

It should be noted that the second ends of the plurality of converters in each phase of the SST system can be connected in parallel, in series, or in series-parallel mixed connection, as shown in FIG. 33, which is a connection diagram of parallel connection.

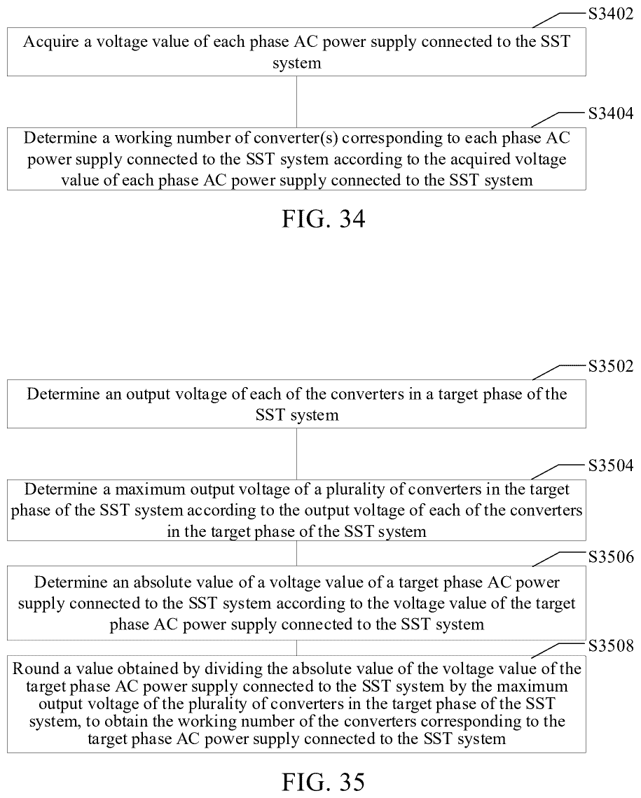

Correspondingly, a control method for an SST system corresponding to the above SST system is also provided in the embodiment of the present disclosure, as shown in FIG. 34, the method includes the following steps.
In S3402, a voltage value of each phase AC power supply connected to the SST system is acquired.
In S3404, a working number of converter(s) corresponding to each phase AC power supply connected to the SST system is determined according to the acquired voltage value of each phase AC power supply connected to the SST system.

The converters of the same phase of this system can synchronously perform wide-range step-up and step-down operation, or they can choose to bypass some converters according to the grid voltage, that is, to make some converters not intervene in the operation of the system or make some converters work in DCX mode, and only make one or several converters work in the step-up or step-down mode. It should be noted that working in DCX mode means not adjusting the switching frequency of the converter.

It should be noted that the working number of converters corresponding to one phase AC power supply connected to the SST system is positively correlated with the absolute value of the voltage value of the corresponding phase AC power supply connected to the SST system. The implementation process of step S3404, as shown in FIG. 35, includes the following steps.
In S3502, an output voltage of each of the converters in a target phase of the SST system is determined.
In S3504, a maximum output voltage of a plurality of converters in the target phase of the SST system is determined according to the output voltage of each of the converters in the target phase of the SST system.
In S3506, an absolute value of a voltage value of a target phase AC power supply connected to the SST system is determined according to the voltage value of the target phase AC power supply connected to the SST system.
In S3508, the value obtained by dividing the absolute value of the voltage value of the target phase AC power supply connected to the SST system by the maximum output voltage of the plurality of converters in the target phase of the SST system is rounded to obtain the working number of the converters corresponding to the target phase AC power supply connected to the SST system.

The target phase AC power supply connected to the SST system is any one phase of each phase AC power supply connected to the SST system. Through the above steps, the number of converters in working state connected to the SST system when each phase AC power supply is connected can be obtained. The voltage of the AC power supply changes according to a sinusoidal waveform, that is to say, the number of converters in working state connected also changes with time.

Based on the same inventive concept, a converter control device is also provided in the embodiment of the present disclosure, as described in the following embodiment. Since the principle of solving the problem in the converter control device embodiment is similar to that of the above-mentioned control method and converter embodiments, the implementation of the converter control device embodiment can refer to the implementation of the above-mentioned control method and converter embodiments, and the repeated parts are not repeated.

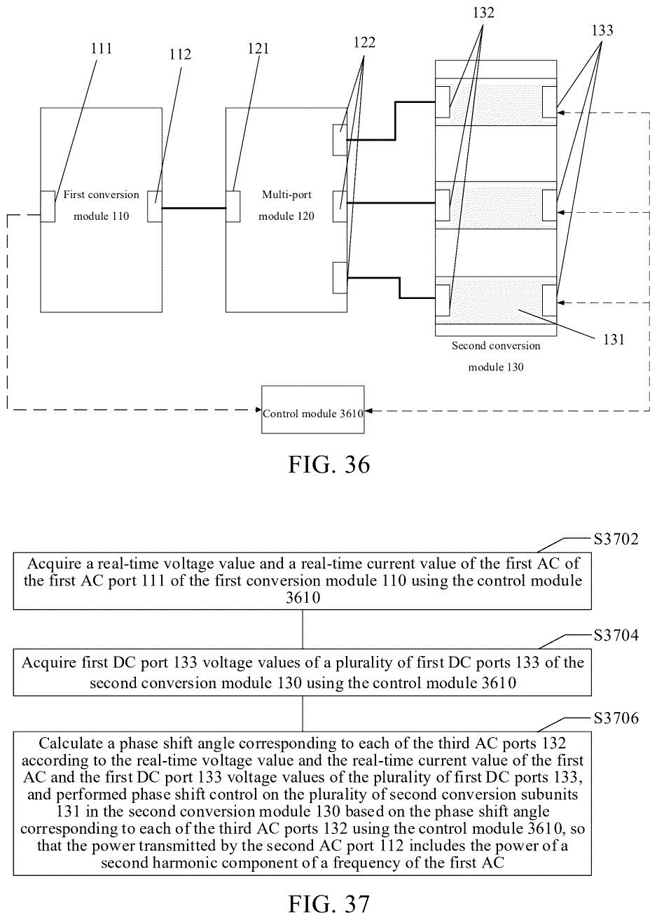

As shown in FIG. 36, the converter control device provided in the embodiment of the present disclosure includes:
a first conversion module 110, a multi-port module 120, a second conversion module 130 and a control module 3610;
the first conversion module 110 includes a first AC port 111 and a second AC port 112, and is used to convert the first AC to the second AC, or convert the second AC to the first AC;
the multi-port module 120 includes a first port 121 and a plurality of second ports 122, and are used to transmit the second AC; the first port 121 is electrically connected to the second AC port 112;
the second conversion module 130 includes a plurality of second conversion subunits 131, each of which includes one third AC port 132 and one first DC port 133, and the plurality of third AC ports 132 are electrically connected to the plurality of second ports 122 in a one-to-one correspondence;
the control module 3610 is electrically connected to the first conversion module 110 and the second conversion module 130, and is used to perform phase shift control on the plurality of second conversion subunits 131 in the second conversion module 130, so that the power transmitted by the second AC port 112 includes the power of a second harmonic component of a frequency of the first AC.

It can be understood that the implementation of the first conversion module 110, the multi-port module 120 and the second conversion module 130 can refer to the above-mentioned embodiments, which will not be repeated here.

In some exemplary embodiments of the present disclosure, the control module 3610 includes: a phase shift angle calculation unit, which is used to: determine a first reference value according to the real-time voltage value and the real-time current value of the first alternating current; calculate the phase shift angle corresponding to the third alternating current ports 132 of any two second conversion subunits 131 according to the first reference value and the first DC port 133 voltage values of the plurality of first DC ports 133.

Specifically, the phase shift angle calculation unit is specifically used to: acquire the active user demand information and reactive user demand information of the current reference value of the first alternating current; generate the current reference value of the first alternating current according to the active user demand information and the reactive user demand information.

In some exemplary embodiments of the present disclosure, each second conversion subunit 131 includes one third AC port 132 and one first DC port 133. Accordingly, the control module 3610 further includes: a phase shift control unit, which is used to: generate a second conversion sub-signal corresponding to each of the second conversion subunits 131 according to the calculated phase shift angle corresponding to the third AC ports 132 of any two second conversion subunits 131; and send the second conversion sub-signal to the corresponding second conversion subunit 131, and perform phase shift control on the plurality of second conversion subunits 131.

In some exemplary embodiments of the present disclosure, the control module 3610 further includes: a working mode determination unit, which is used to: acquire a current reference value of the first alternating current; and determine a working mode of the converter based on a product of the current reference value of the first alternating current and the voltage reference value of the first alternating current.

In some exemplary embodiments of the present disclosure, the first conversion module 110 includes: a first conversion subunit I 210, including a first AC port 111 and a first sub-port 211; a first conversion subunit II 220, including a second AC port 112 and a second sub-port 221, where the second sub-port 221 is electrically connected to the first sub-port 211. Correspondingly, the control module 3610 also includes: a rectifier control unit, which is used to: control the first conversion subunit I 210 to convert the first AC input to the first AC port 111 into the second DC, and output the second DC to the first conversion subunit II 220 via the first subport 211; control the first conversion subunit II 220 to convert the second DC input to the second subport 221 into the second AC, and output the second AC via the second AC port 112; and control the second conversion subunit 131 to convert the AC power input to the third AC port 132 into the DC power of the first port 121, and output it via the first DC port 133.

During specific implementation, the rectifier control unit is also used to: determine the real-time current value of the first alternating current; calculate a turn-off lag angle of each of the second conversion subunits 131 compared to the first conversion subunit II 220 according to the real-time current value of the first alternating current, the current reference value of the first alternating current, and the voltage value of the first DC port 133 of the plurality of first DC ports 133 of the second conversion module 130; and control the turn-off of the plurality of second conversion subunits 131 based on the turn-off lag angle of each of the second conversion subunits 131 compared to the first conversion subunit II 220.

In some embodiments of the present disclosure, the control module 3610 further includes: an inverter control unit, which is used to: control the first conversion subunit II 220 to convert the second AC input via the second AC port 112 into the first DC, and output the first DC to the first subport 211 of the first conversion subunit I 210 via the second subport 221; control the first conversion subunit I 210 to convert the first DC input to the first subport 211 into the first AC, and output the first AC via the first AC port 111; and control the second conversion subunit 131 to convert the DC input to the first port 121 of the first DC port 133 into AC, and output the AC via the third AC port 132.

In some embodiments of the present disclosure, the first conversion module 110 includes: a first conversion subunit III. Correspondingly, the rectifier control unit is used to: control the first conversion subunit III to convert the first AC input to the first AC port 111 into the second AC, and output the second AC via the second AC port 112. The inverter control unit is used to: control the first conversion subunit III to convert the second AC input to the second AC port 112 into the first AC, and output the first AC through the first AC port.

In some embodiments of the present disclosure, the control module 3610 also includes a bypass control unit, which is used to: determine a bypass number of the plurality of second conversion subunits 131 according to a voltage reference value of the first AC; and control a corresponding number of second conversion subunits 131 in the second conversion module 130 to short-circuit based on the bypass number. It should be noted that the bypass number is negatively correlated with the absolute value of the voltage reference value of the first AC.

Based on the same inventive concept, the embodiment of the present disclosure also provides a working method applied to the above-mentioned converter control device, as described in the following embodiments. Since the principle of solving the problem in the working method embodiment of the converter control device is similar to that in the above-mentioned converter control device embodiment, the implementation of the working method embodiment of the converter control device can refer to the implementation of the above-mentioned converter control device embodiment, and the repeated parts will not be repeated.

As shown in FIG. 37, a working method of a converter control device provided by an embodiment of the present disclosure includes the following steps.
In S3702, a real-time voltage value and a real-time current value of the first AC of the first AC port 111 of the first conversion module 110 are acquired using the control module 3610.
In S3704, first DC port 133 voltage values of a plurality of first DC ports 133 of the second conversion module 130 are acquired using the control module 3610.
In S3706, a phase shift angle corresponding to each of the third AC ports 132 is calculated according to the real-time voltage value and the real-time current value of the first AC and the first DC port 133 voltage values of the plurality of first DC ports 133 and phase shift control is performed on the plurality of second conversion subunits 131 in the second conversion module 130 based on the phase shift angle corresponding to each of the third AC ports 132 using the control module 3610, so that the power transmitted by the second AC port 112 includes the power of a second harmonic component of a frequency of the first AC.

Specifically, the working method of the converter control device also includes:
determining a first reference value according to the real-time voltage value and the real-time current value of the first alternating current, and calculating a phase shift angle corresponding to the third AC port 132 of any two second conversion subunits 131 according to the first reference value and the first DC port 133 voltage value of the plurality of first DC ports 133 using the phase shift angle calculation unit.

Specifically, the working method of the converter control device also includes:
generating a second conversion sub-signal corresponding to each of the second conversion subunits 131 according to the calculated phase shift angle corresponding to the third AC ports 132 of any two second conversion subunits 131 using the phase shift control unit;
sending the second conversion sub-signal to the corresponding second conversion subunit 131 and performing phase shift control on the plurality of second conversion subunits 131 using the phase shift control unit.

In some embodiments of the present disclosure, the provided working method of the converter control device also includes:
acquiring a current reference value of the first alternating current using the control module 3610;
determining a working mode of the converter based on a product of the current reference value of the first alternating current and a voltage reference value of the first alternating current using the control module 3610.

Specifically, the working mode determination unit can be used to acquire the current reference value of the first alternating current, and the working mode of the converter can be determined based on the product of the current reference value of the first alternating current and the voltage reference value of the first alternating current.

In some embodiments of the present disclosure, the provided working method of the converter control device also includes:
determining a bypass number of the plurality of second conversion subunits 131 according to a voltage reference value of the first alternating current using the control module 3610;
controlling a corresponding number of the second conversion subunits 131 in the second conversion module 130 to short-circuit based on the bypass number using the control module 3610.

Specifically, the bypass control unit can be used to determine the bypass number of multiple second conversion subunits 131 according to the voltage reference value of the first alternating current, and the corresponding number of second conversion subunits 131 in the second conversion module 130 can be short-circuited based on the bypass number.

Based on the same inventive concept, a converter is also provided in the embodiment of the present disclosure, as described in the following embodiment. Since the principle of solving the problem in the converter embodiment is similar to the above-mentioned control method and converter embodiment, the implementation of the converter can refer to the implementation of the above-mentioned control method and converter embodiment, and the repeated parts will not be repeated.

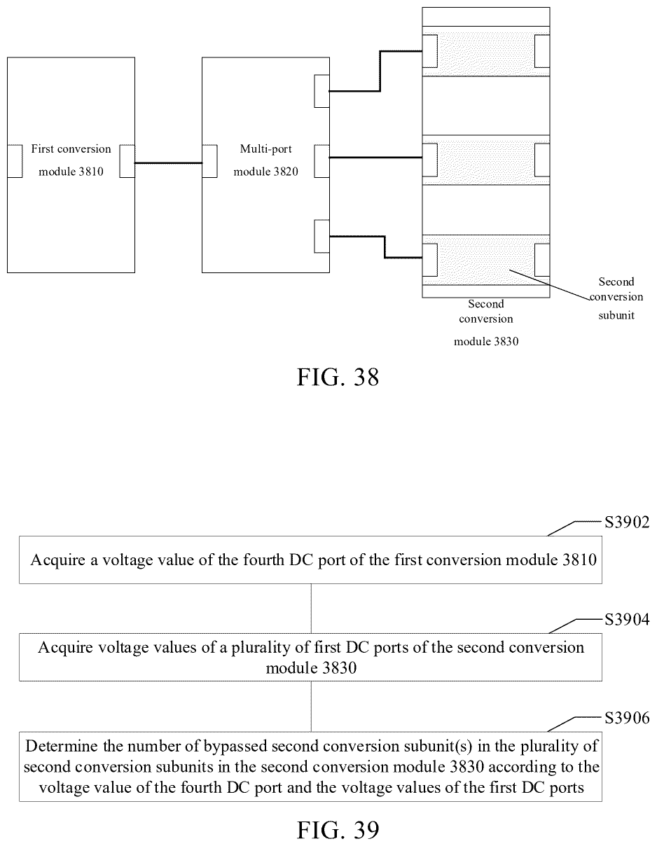

As shown in FIG. 38, the embodiment of the present disclosure provides a converter, including:
a first conversion module 3810, including a fourth DC port and a fourth AC port, and used to convert a fourth DC to a fourth AC, or convert the fourth AC to the fourth DC.
a multi-port module 3820, including a first port and a plurality of second ports, and used to transmit the fourth AC; where the first port is electrically connected to the fourth AC port.
a second conversion module 3830, including a plurality of second conversion subunits, each of which includes one third AC port and one first DC port, and the plurality of third AC ports are electrically connected to the plurality of second ports in a one-to-one correspondence.

It should be noted that the second conversion subunit is used to convert the third AC to the first port DC, or convert the first port DC to the third AC. It can be understood that the implementation of the first conversion module 3810, the multi-port module 3820 and the second conversion module 3830 is similar to the first conversion module 110, the multi-port module 120 and the second conversion module 130 in the above-mentioned embodiments, and the embodiment of the present disclosure will not be repeated here.

In some embodiments of the present disclosure, the multi-port module 3820 includes a transformer; the transformer includes a primary winding branch and a plurality of secondary winding branches; the number of the secondary winding branches is equal to the number of the second ports. The secondary winding branch includes: a secondary winding and an excitation inductor, and the secondary winding and the excitation inductor are connected in parallel.

Accordingly, the present disclosure embodiment also provides a control method for a converter shown in FIG. 39, which is applied to the converter shown in FIG. 38. As shown in FIG. 39, the method includes the following steps.
In S3902, a voltage value of the fourth DC port of the first conversion module 3810 is acquired.
In S3904, voltage values of a plurality of first DC ports of the second conversion module 3830 are acquired.
In S3906, the number of bypassed second conversion subunit(s) in the plurality of second conversion subunits in the second conversion module 3830 is determined according to the voltage value of the fourth DC port and the voltage values of the first DC ports.

It should be noted that the number of bypassed second conversion subunits in the plurality of second conversion subunits in the second conversion module 3830 is negatively correlated with the voltage value of the fourth DC port. Accordingly, in some exemplary embodiments of the present disclosure, the control method for the converter provided further includes: based on the number of bypassed second conversion subunits in the plurality of second conversion subunits in the second conversion module 3830, controlling a corresponding number of second conversion subunits in the second conversion module to short-circuit.

In some embodiments of the present disclosure, the control method for the converter further includes: performing phase shift control on the converter, that is, calculating the phase shift angle corresponding to each third AC port based on the real-time voltage value and the real-time current value of the fourth AC and the first DC port voltage values of the plurality of first DC ports, and performing phase shift control on the plurality of second conversion subunits in the second conversion module 3930 based on the phase shift angle corresponding to each third AC port. The difference is that the phase shift angle corresponding to each third AC port is the same and fixed to achieve the voltage reduction target of the converter and to achieve the regulation of the voltage of the fourth DC port or the voltage of the first DC port.

In the converter provided in the embodiments of the present disclosure, it is set that the first conversion module includes the first AC port and the second AC port, and converts the first AC to the second AC, or converts the second AC to the first AC; it is set that the multi-port module transmits the second AC; and it is set that the second conversion module includes a plurality of second conversion subunits, and the power transmitted by the second AC port includes the power of a second harmonic component of a frequency of the first AC. The bidirectional flow of power can be achieved, and furthermore, the power transmitted by the second AC including the power of a second harmonic component of a frequency of the first AC realizes the single-stage topology structure of the converter without a large capacitor and a large inductor, which greatly improves the power density of the converter.

Those skilled in the art can understand that various aspects of the present disclosure can be implemented as a system, method or program product. Therefore, various aspects of the present disclosure can be specifically implemented in the following forms, namely: a complete hardware implementation, a complete software implementation (including firmware, microcode, etc.), or an implementation combining hardware and software aspects, which can be collectively referred to as “circuit”, “module” or “system” here. It should be noted that although several modules or units of the device for action execution are mentioned in the above detailed description, such division is not mandatory. In fact, according to the implementations of the present disclosure, the features and functions of two or more modules or units described above can be embodied in one module or unit. On the contrary, the features and functions of one module or unit described above can be further divided into multiple modules or units to be embodied.

In addition, although the steps of the method in the present disclosure are described in a specific order in the drawings, this does not require or imply that the steps must be performed in this specific order, or that all the steps shown must be performed to achieve the desired results. Additionally or alternatively, some steps can be omitted, multiple steps can be combined into one step for execution, and/or one step can be decomposed into multiple steps for execution, etc.

Through the description of the above implementations, it is easy for those skilled in the art to understand that the example implementations described here can be implemented by software or by combining software with necessary hardware. Therefore, the technical solutions according to the implementations of the present disclosure can be embodied in the form of a software product, which can be stored in a non-transitory storage medium (which can be a CD-ROM, a USB flash drive, a mobile hard disk, etc.) or on a network, and includes several instructions to enable a computing device (which can be a personal computer, a server, a mobile terminal, or a network device, etc.) to execute the methods according to the implementations of the present disclosure.

After considering the specification and practicing the contents disclosed here, those skilled in the art will easily think of other implementations of the present disclosure. The present disclosure is intended to cover any variation, use or adaptation of the present disclosure, which follows the general principles of the present disclosure and includes common knowledge or customary technical means in the technical field not disclosed in the present disclosure. The specification and embodiments are to be regarded as exemplary only, and the true scope and spirit of the present disclosure are indicated by the appended claims.

What is claimed is:

1. A converter, comprising:
a first conversion module, comprising a first alternating current (AC) port and a second AC port, and configured to convert a first AC into a second AC, or to convert the second AC into the first AC;
a multi-port module, comprising a first port and a plurality of second ports, and configured to transmit the second AC; wherein the first port is electrically connected to the second AC port; and
a second conversion module, comprising a plurality of second conversion subunits, wherein each of the second conversion subunits comprises one third AC port and one first direct current (DC) port, and the plurality of third AC ports are electrically connected to the plurality of second ports in a one-to-one correspondence;
wherein power transmitted by the second AC port comprises power of a second harmonic component of a frequency of the first AC.

2. The converter according to claim 1, wherein the multi-port module comprises a transformer;
the transformer comprises a primary winding branch and a plurality of secondary winding branches;
a number of the secondary winding branches is equal to a number of the second ports.

3. The converter according to claim 2, wherein the secondary winding branch comprises:
a secondary winding and an excitation inductor;
wherein the secondary winding and the excitation inductor are connected in parallel.

4. The converter according to claim 1, wherein the first conversion module comprises:
a first conversion subunit I, comprising the first AC port and a first subport; and
a first conversion subunit II, comprising the second AC port and a second subport;
wherein the second subport is electrically connected to the first subport.

5. The converter according to claim 4, wherein the first conversion subunit I comprises: a first conversion bridge arm and a second conversion bridge arm, the first conversion bridge arm and the second conversion bridge arm are electrically connected in parallel; a midpoint of the first conversion bridge arm and a midpoint of the second conversion bridge arm constitute the first AC port;
wherein a current flow direction of the first conversion bridge arm is opposite to a current flow direction of the second conversion bridge arm.

6. The converter according to claim 5, wherein the first conversion bridge arm comprises a first conversion switching transistor I and a first conversion switching transistor II connected in series; and the second conversion bridge arm comprises a first conversion switching transistor III and a first conversion switching transistor IV connected in series.

7. The converter according to claim 4, wherein the first conversion subunit II comprises: at least one first conversion capacitor I and a first conversion circuit connected in parallel with the at least one first conversion capacitor I.

8. The converter according to claim 1, wherein the first conversion module comprises a first conversion subunit III, and the first conversion subunit III comprises: a first bridge circuit;
a first bridge arm of the first bridge circuit comprises two first bridge capacitors connected in series; a second bridge arm of the first bridge circuit comprises two first bridge bidirectional switches connected in series; a midpoint of the first bridge arm of the first bridge circuit and a midpoint of the second bridge arm of the first bridge circuit constitute the second AC port.

9. The converter according to claim 1, wherein the first conversion module comprises a first conversion subunit III, and the first conversion subunit III comprises: a second bridge circuit;
a first bridge arm of the second bridge circuit comprises a second bridge active switch I and a second bridge active switch II connected in series; a second bridge arm of the second bridge circuit comprises a second bridge active switch III and a second bridge active switch IV connected in series, and a midpoint of the first bridge arm of the second bridge circuit and a midpoint of the second bridge arm of the second bridge circuit constitute the second AC port.

10. A control method for a converter, applied to the converter according to claim 1, wherein the control method for the converter comprises:
acquiring a real-time voltage value and a real-time current value of the first AC of the first AC port of the first conversion module;
acquiring first DC port voltage values of a plurality of first DC ports of the second conversion module; and
calculating a phase shift angle corresponding to each of the third AC ports according to the real-time voltage value and the real-time current value of the first AC and the first DC port voltage values of the plurality of first DC ports, and performing a phase shift control on the plurality of second conversion subunits in the second conversion module based on the phase shift angle corresponding to each of the third AC ports, so that the power transmitted by the second AC port comprises the power of the second harmonic component of the frequency of the first AC.

11. The control method for the converter according to claim 10, wherein each of the second conversion subunits comprises one third AC port and one first DC port;
calculating the phase shift angle corresponding to each of the third AC ports according to the real-time voltage value and the real-time current value of the first AC and the first DC port voltage values of the plurality of first DC ports, comprises:
determining a first reference value according to the real-time voltage value and the real-time current value of the first AC; and
calculating the phase shift angle corresponding to the third AC ports of any two of the second conversion subunits according to the first reference value and the first DC port voltage values of the plurality of first DC ports.

12. The control method for the converter according to claim 11, wherein performing the phase shift control on the plurality of second conversion subunits in the second conversion module based on the phase shift angle corresponding to each of the third AC ports, comprises:
generating a second conversion sub-signal corresponding to each of the second conversion subunits according to the calculated phase shift angle corresponding to the third AC ports of any two of the second conversion subunits; and
sending the second conversion sub-signal to the corresponding second conversion subunit, and performing the phase shift control on the plurality of second conversion subunits.

13. The control method for the converter according to claim 11, further comprising:
acquiring a current reference value of the first AC; and
determining a working mode of the converter based on a product of the current reference value of the first AC and a voltage reference value of the first AC.

14. The control method for the converter according to claim 13, wherein the first conversion module comprises: a first conversion subunit I, comprising the first AC port and a first subport; and a first conversion subunit II, comprising the second AC port and a second subport; wherein the second subport is electrically connected to the first subport;
when determining that the working mode of the converter is a rectification mode, the control method further comprises:
controlling the first conversion subunit I to convert the first AC input to the first AC port into a second DC, and output the second DC to the first conversion subunit II via the first subport; and
controlling the first conversion subunit II to convert the second DC input to the second subport into a second AC, and output the second AC via the second AC port.

15. The control method for the converter according to claim 14, wherein when determining that the working mode of the converter is the rectification mode, the control method further comprises:
determining a real-time current value of the first AC;
calculating a turn-off lag angle of each of the second conversion subunits compared to the first conversion subunit II according to the real-time current value of the first AC, the current reference value of the first AC, and the first DC port voltage values of the plurality of first DC ports of the second conversion module; and
controlling a turn-off of the plurality of second conversion subunits based on the turn-off lag angle of each of the second conversion subunits compared to the first conversion subunit II.

16. The control method for the converter according to claim 14, wherein when determining that the working mode of the converter is an inversion mode, the control method further comprises:
controlling the first conversion subunit II to convert the second AC input through the second AC port into the first DC, and output the first DC to the first subport of the first conversion subunit I through the second subport; and
controlling the first conversion subunit I to convert the first DC input to the first subport into the first AC, and output the first AC through the first AC port.

17. The control method for the converter according to claim 13, wherein the first conversion module comprises: a first conversion subunit III;
when determining that the working mode of the converter is a rectification mode, the control method further comprises:
controlling the first conversion subunit III to convert the first AC input to the first AC port into the second AC, and output the second AC through the second AC port.

18. The control method for the converter according to claim 17, wherein when determining that the working mode of the converter is an inversion mode, the control method further comprises:
controlling the first conversion subunit III to convert the second AC input to the second AC port into the first AC, and output the first AC through the first AC port.

19. The control method for the converter according to claim 13, wherein when determining that the working mode of the converter is a rectification mode, the control method further comprises:
controlling the second conversion subunit to convert an AC input to the third AC port into a first port DC, and output the first port DC through the first DC port.

20. The control method for the converter according to claim 19, wherein when determining that the working mode of the converter is an inversion mode, the control method further comprises:
controlling the second conversion subunit to convert the first port DC input to the first DC port into the AC, and output the AC through the third AC port.

21. The control method for the converter according to claim 13, wherein acquiring the current reference value of the first AC comprises:
acquiring active user demand information and reactive user demand information of the current reference value of the first AC; and
generating the current reference value of the first AC according to the active user demand information and reactive user demand information.

22. The control method for the converter according to claim 11, further comprising:
determining a bypass number of the plurality of second conversion subunits according to a voltage reference value of the first AC; and
controlling a corresponding number of the second conversion subunits in the second conversion module to short-circuit based on the bypass number.

23. The control method for the converter according to claim 22, wherein the bypass number is negatively correlated with an absolute value of the voltage reference value of the first AC.

24. A solid-state transformer (SST) system, wherein each phase of the SST system comprises a plurality of converters according to claim 1, each of the converters comprises a first end and a second end;
the first ends of the plurality of converters in each phase of the SST system are sequentially connected in series and then connected to a same phase AC power supply; and
the second ends of the plurality of converters in each phase of the SST system are electrically connected to form an output end of each phase of the SST system.
